(19) United States
(12) Patent Application Publication
(10) Pub. No.: US 2004/0235550 A1
(43) Pub. Date: Nov. 25, 2004

(54) Game device

(76) Inventors: Gordon McNally, London (GB); John Bentley, Sussex (GB)

Correspondence Address: FISH & RICHARDSON, PC, 12390 EL CAMINO REAL, SAN DIEGO, CA, 92130-2081, US

(21) Appl. No.: 10/754,349

(22) Filed: Jan. 9, 2004

Related U.S. Application Data
(63) Continuation-in-part of application No. PCT/GB02/03053, filed on Jul. 3, 2002.

(30) Foreign Application Priority Data
Jul. 20, 2001 (GB) 01177556.7
Dec. 4, 2003 (GB) 0328153.2

(51) Int. Cl. G06F 17/00

(52) U.S. Cl. 463/16

(57) ABSTRACT

A game device for playing lottery-type games of chance includes a component programmed with software for playing one or more games, at least one game having one or more win levels. The component includes a plurality of ports being connectable to a printed circuit board in any of a plurality of configurations. Each configuration corresponds to an associated win level. The device further includes security mechanisms to inhibit a user from determining the configuration prior to the game being played. A method of producing such a game device includes providing a component programmed with software to run the game, and selectively connecting a plurality of ports on the component to a plurality of tracks on the printed circuit board.

### STATEMENT OF RELATED APPLICATIONS

This application is a continuation-in-part of, and under 35 USC §120 claims priority to, Patent Cooperation Treaty (PCT) International Application Serial No. PCT/GB02/03053, filed on Jul. 3, 2002, which claims priority to UK application No. 01177556.7 filed on Jul. 20, 2001 and this application is a CIP of and under 35 USC §119 claims priority to UK Application No. 0328153.2, filed Dec. 4, 2003. The aforementioned applications are explicitly incorporated herein by reference in their entirety and for all purposes.

### BACKGROUND

The present invention relates to electronic game devices and in particular an electronic game device that can be used in an instant lottery or other promotional games.

Conventional lottery tickets are currently produced by a number of international manufacturers for lotteries in almost all countries of the world. These tickets are usually constructed of paper or thin paper and print laminates. Many variations of lottery games exist. Typically “instant win” type of lottery games will utilize a paper ticket that has been processed through a highly automated printing machine which creates not only game graphics, but also prints on each individual ticket unique game play data such as a barcode or other unique identifier.

The unique game play data makes each ticket a potential winner, although since the games are created and the tickets are printed from a “seeded deck,” it is predetermined which tickets are winners and which are non-winners. To play the game, a purchaser typically scratches off a number of latex patches to reveal if the ticket is a winner and if so, present the ticket to a ticket vendor. The barcode is read by a barcode scanner on a lottery terminal to confirm whether the ticket is a winner so that the purchaser can be awarded the winnings.

In addition, a unique VIRN (Void If Removed Number) may be contained under a latex patch on each ticket. This number is designed to be a human-generated code, entered, into the lottery terminal once the barcode on the ticket is swiped and that can be used by lottery officials as a secondary security device.

Conventional lottery tickets appeal to consumers because they provide an “instant win” and an instant or near-instant validation as a winner in order to expedite payment of the winnings. However, a typical conventional lottery ticket usually can only contain up to five or six games, even on a large four-by-six inch ticket. If many games are desired, several tickets need to be purchased. Conventional tickets also do not offer a dynamic or interactive element to the gaming experience.

An alternative is needed that provides the same instantaneous “win” as conventional tickets but which can provide for many games and multiple wins and which provides additional attraction to the player.

### SUMMARY

This document discloses a game device that includes a component programmed with software for playing one or more games. At least one game has one or more win levels. The component includes a plurality of ports being connectable to a printed circuit board in any of a plurality of configurations. Each configuration corresponds to an associated win level. A method of producing such a game device includes providing a component programmed with software to run the game. The method further includes selectively connecting a plurality of ports on the component to a plurality of tracks on a printed circuit board in one of a plurality of configurations.

The device can include a first window group for displaying characters selected by the player and recorded by a game machine, a second window group corresponding to the first window group, a lock control operable to allow or prevent a game being played, and a play control operable to start the game causing characters to come to rest in the windows of the second group.

According to another aspect a device is provided for playing a game. The device includes a window group for displaying characters, a lock control operable to allow or prevent a game being played, and a play control operable to start the game causing characters to appear to come to rest in the windows of the window group in sequence. The device may include a hold control to retain selected characters in the window group.

The game devices may be hand-held, and may be in formed as a card and powered by batteries or solar cells located in the device, and run under the control of appropriate software. The play control may be a button or at least one sound or light activated switch, and the device may be made ready for play by a suitable security tool.

In one embodiment, a game device generally includes a printed circuit board and a microprocessor chip mounted thereon programmed with software to run the particular game type. The device can be housed in a case and further include one or more windows in which characters generated during game play or other information can be displayed, and one or more controls such as a button to start or stop game play. Additional devices such as a sound generator may also be included. A power source such as a battery or solar cell or other such device can also be included. The case can have dimensions similar to a credit card or the like, or other shape such as a novelty or promotional item.

The microprocessor chip will be programmed prior to assembly with characters to be generated for each game, including a winning character or characters if applicable. There can for example, be only one level of win, i.e. either win or lose or there can be several different levels of win.

As with printed lottery type tickets, the devices will be “seeded” so that only certain predetermined devices will be programmed with a winning game or games. For example, ten percent of produced devices can be designated as winning games at a first level of prize, five percent at a second level, and one percent at a third level, and only one device at the highest level. The number of winning games can be varied as desired, depending on the programming applied to the chips. In some promotional games it may even be arranged so that all games give at least a base level win but a certain proportion give higher level wins.

All chips for a particular game type will be programmed with the same software so that it is not necessary to produce a different chip for each win level, which reduces the cost of production for each game. To obtain different win levels the chips are bonded to the printed circuit board according to any of different configurations. This is achieved by having a plurality of ports or pins on the chip and a plurality of connection paths on the printed circuit board so arranged that the chip can be connected to the printed circuit board in a number of different configurations.

### BRIEF DESCRIPTION OF THE DRAWINGS

These and other aspects will now be described in detail with reference to the following drawings.

FIG. 1 is a front elevation of a game device.

FIG. 2 is a side elevation of the device shown in FIG. 1.

FIG. 3 is a rear elevation of the device shown in FIGS. 1 and 2.

FIG. 4 is a front elevation of a game device in accordance with an alternative embodiment.

FIG. 5 is a side elevation of the device shown in FIG. 4.

FIG. 6 is a rear elevation of the device shown in FIGS. 4 and 5.

FIGS. 7a, 7b and 7c illustrate various connections between a game device control component and a printed circuit board.

FIG. 8 is a front elevation of another game device.

FIG. 9 is a side elevation of the game device shown in FIG. 8.

### DETAILED DESCRIPTION

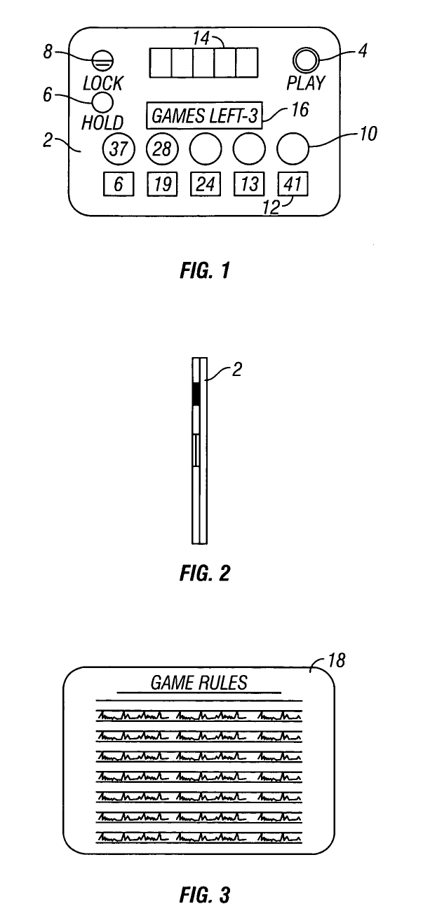

The system and techniques described relate to electronic game devices that can be manufactured at low cost, and play one or more games of chance. Referring to FIGS. 1 to 3, a game device 2 is formed of two or more layers that are fused together to have the approximate thickness and rectangular shape of a credit card, as shown in FIG. 2. The game device 2 includes a play-push button 4, a hold push-button 6, and a lock push-button 8. The lock push-button can be recessed to reduce the risk of being engaged accidentally.

A first window group 10 of display windows and a second window group 12 of display windows are spaced along the length of the device in two parallel straight lines. The number and/or arrangement of display windows in the second window group 12 corresponds to the number and/or arrangement of display windows in the first window group 10. At the start of a game, all of the display windows are preferably blank. The device is powered by batteries or solar cells 14 housed in the game device 2 together with appropriate software. A status window 16 displays relevant information such as, for example, “number of games yet to play,” “win,” “credit,” “locked,” “game,” “game over” and “hold,” or the like.

Referring to FIG. 3, rules 18 of the game to be played are written on a rear face of the device 2. In order to play one game, a player chooses five numbers between 0 and 99, which may be selected by a keyboard of a game dispenser vending machine. Alternatively, the chosen numbers may be selected by a player on a pre-printed ticket that is then inserted into the game dispenser vending machine (not shown). Regardless of the method used to choose the selected numbers by the player, the numbers are electronically recorded by the dispensing machine along with any other required information.

The machine then prints the chosen numbers so that they are displayed in the display windows 12. The game device 2 is then dispensed from the game dispenser vending machine. In an example, the game may be paid for by putting money in the vending machine or giving money to an official who will operate the machine for the game player. The information for carrying out this step may be printed on the back of the device 2 as shown in FIG. 3 along with rules and conditions of playing the game.

The device is unlocked by pressing the lock button 8, and the play button 4 is then pressed to re-start the game. This causes all the display windows in the first window group 10 to go blank. Characters then appear to move across a first display window of the first window group 10 until a character appears to come to rest in the first display window, i.e. where the character is displayed in the right-most window. After a small delay, a second window displays an effect of characters continuing moving across the second window of the display windows 10 until a character comes to rest in that second window. This process is repeated until all the display windows in the first window group 10 display a character. If any of the characters in the display windows 10 match a character in the corresponding window of the display windows 12 this will be classed as a win. The extent of the win can depend on the location of the matching characters in the windows 10 and 12 and on the character of matching characters in the windows 10 and 12. The characters can be numbers, alphanumeric characters, letters or other symbols.

If only some of the characters in the window groups 10 and 12 are matching, then these characters are held in the display windows 10 by pressing the hold button 6 and rolling over these characters into the next game to be played. If however the player wishes to accept a prize for the win obtained in the last game, this can be done by pressing the lock button 8 which means that no further games can be accidentally played to erase the winning character(s). The game device 2 can then be sent back to the game organizers for verification and payment of the prize.

In accordance with one aspect, a “winning” character is a character corresponding to a character which has been preselected by an organizer of the game. In another aspect, the “winning” character is a character corresponding to a character preselected by the player.

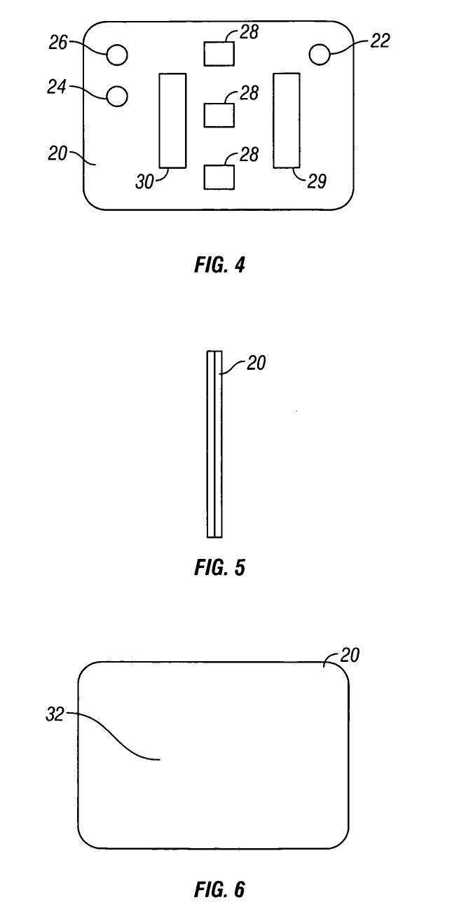

Referring now to FIGS. 4 to 6, a game device 20 is formed of two layers that are fused together to have the approximate thickness and shape of a credit card as shown in FIG. 5. The device includes a play push-button 22, a hold push button 24, and a lock push-button 26 which is recessed to avoid the risk of accidental or inadvertent activation.

A number of display windows 28 are provided in a front face of the game device 20. In one example, the display windows 28 are aligned and spaced along the width of the central part of the front face of the game device 20 in a straight line. At the start of the game all of the display windows 28 are blank, or devoid of displaying any characters. The game device 20 can be powered by batteries or solar cells 29 disposed in the game device 20, together with appropriate software to control the game device 20 and run one or more games. A window 30 displays relevant information such as “number of games yet to play,” “win,” “credit,” “locked,” “game,” “game over” and “hold.”

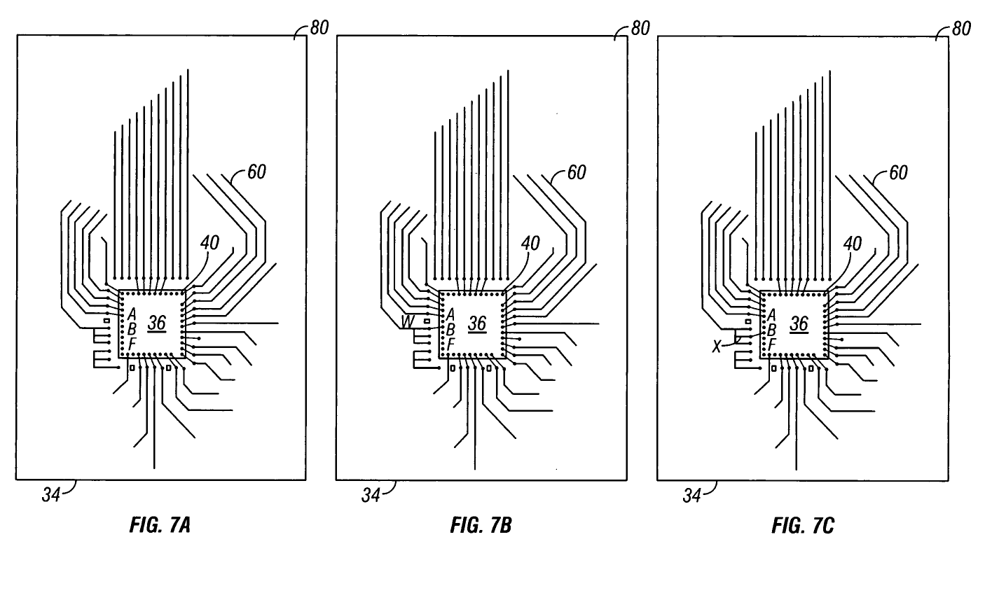

Referring to FIG. 6, the rules 32 of the game to be played may be provided on the rear face of the game device 20, such as written or described thereon. In one operation, a large number of the card devices 20 are distributed, and a number of these cards are programmed to produce winning numbers in one or more of the windows 28. The number of winning characters can be predetermined and/or limited, or randomly generated. For example, in a three-window game device 20, a first win level can be awarded to a card displaying winning characters in all three windows 28, a second win level for a card displaying winning characters in two of the windows 28, and a third win level for a card displaying a winning character in only one of the windows 28. Alternatively, the second and third win level may be awarded only to cards that produce winning characters in selected ones or one of the windows 28.

In order to play the game, the device 20 is unlocked by pressing the lock button 26, and game is started by pressing the play button 22. In one example, upon starting the game, the display windows 28 go blank. Characters, such as numbers, letters, symbols, etc., then start moving across the first of the display windows 28 until a character comes to rest in that first window. After a small delay, characters start moving across the second window of the display windows 28 until a character comes to rest in the second window. The process is continued until a third window 28 displays a character. A “win” can be classified if any of the characters in the displays windows 28 corresponds to preselected winning characters. As previously mentioned, the extent of the win can depend upon the character and/or location of the characters in the windows 28.

If only one or two of the windows 28 display winning characters then a decision can made by the player whether or not to hold these characters in those display windows 28 by pressing the hold button 24 and rolling over these characters into the next game to be played. If however the player wishes to accept the prize for the characters obtained in the last game, this can be done by pressing the lock button 26 so that no further games can accidentally be played to erase the winning characters or character. The device 20 can then be sent to the game organizers for verification and payment of a prize.

The software of the game devices is specifically designed to drive the basic functions of the game control. The software can include various levels or components that are particularly designed to enable a specific game to be played within the game device, in accordance with a design of the one or more games playable by the game devices. Various electronic components can also be specifically designed to work within the thinness of the game devices. The game card and its variations can also be displayed and played as a video game with the same or similar graphics on a video screen or television set as a stand alone coin-operated amusement machine.

The size or area of the screens 10, 12 and 28 is preferably small in order to accommodate the particular games to be played on these devices. The shape and size of these windows can be selected in accordance with the way the characters move within the windows to make the games attractive to the players. Various sizes and/or shapes are possible. For instance, the device illustrated in FIGS. 4 to 6 has three small rectangular or oval windows 28, while the device illustrated in FIGS. 1 to 3 has circular windows 10 and rectangular windows 12.

The game devices 2 and 20 can be manufactured using thin film technology to reduce the thickness of the various components, in particular microchip or integrated circuit components which govern the working features of the game. In one example, the thickness of the game devices can be approximately 2 millimeters. Because these devices are thin, they can be described as a gamecard or a ticket, terms that can assist in the selling of the game devices 2 and 20, and which renders them suitable for promotions and lotteries, as will be described further below.

The devices 2 and 20 include depressible lock buttons 8 and 26 to ensure that no further games can accidentally be played to erase the winning characters or character. As an alternative to the above-described manual lock feature system, the game devices 2 and 20 can have an automatic lock built in to their program. The automatic lock ensures that a winning character obtained while playing the game is automatically locked into the window display, thereby preventing the player from losing a winning character obtained while playing the game. In one example game device, the operator or purchaser can chose whether to use the manual or the automatic locking system.

The card-like game devices 2 and 20 can be powered by a standard watch battery. However, in order to retain the card-like appearance of the devices, an alternative battery system may be used, which includes electrolytic negative and positive pastes that can be installed into the thickness of the card of the game devices 2 and 20. This installation will usually be carried out during the manufacture of the game device by cutting two holes through the thickness of the card-like device and installing the electrolytic paste into the device. This paste is then held in place by a plastic foil located on both sides of the device, and contact points protrude from the paste to make electrical contact with the software of the game device.

When all the windows 10 and 28 of the game devices 2 and 20 present winning characters, the device software can provide a security code which will automatically display itself in these windows either as an alternative to, or in addition to, the winning characters. This security code can include a different type of character or characters than those related to the game. If the game card is tampered with, this security code is not displayed, thereby warning the game organizers not to pay out a prize. A range of ink jet or holographic markings can also be inscribed onto the exterior surface of the card device as an additional precaution to control the use of the device at all stages.

The software may also include code to provide a display of the starting date of a game when a player activates the card device. This display can be shown in the corners of one or more of the windows 10 and 28, or on a separate strip on the card device. This display can be operated automatically by a pull tag on the device battery to assure the player that the card device has not been tampered with.

In a game device 34 shown in FIGS. 7a to 7c, a component 36 is provided, programmed with all software necessary for running a chosen game, such as the type requiring the matching of three characters. The component 36 has a number of ports 40 that are connected to the tracks 60 disposed on a printed circuit board (PCB) 80. The ports 40 can be bonded to the tracks 60 using thin wire elements onto the PCB to control the function of the device—e.g. operate the displays, buttons, connect power, sound, etc.

A number of the ports A to F can be reserved for determining a prize level of a game being played. The combinations in which these ports are bonded to the tracks on the PCB determine which prize level will be shown. For example FIG. 7a shows that none of the ports A through F are connected to the PCB 80, which can result in a non-winning combination. FIG. 7b, on the other hand, shows port A is connected to track W to produce a winning combination matching of three numbers e.g. of 11, 11, 11. In FIG. 1c, port B is bounded to track X to provide a winning combination of, for example 22, 22, 22. Various configurations of connections between the ports 40 and the tracks 60 can be used. Depending on the number of ports 40 set aside for prize determination, the number of bonding combination that can be used can number in the hundreds or more. For example, using seven ports 40 can provide 728 different unique combination configurations, eight ports 40 can provide 256 unique combination configurations, etc. A device can include more than one winning combination if a plurality of plays have been programmed into the device.

The component 36 may be an integrated circuit, such as an application-specific integrated circuit (ASIC), or other electronic chip such as a microchip. The ports 40 can include pins or other electrical conducting mechanism. Once the component 36 is placed on the PCB, the ports 40 can be bonded to the required tracks 60 of the PCB 80 and set in resin. Alternatively, the tracks 60 of the PCB 80 and ports 40 of the component 36 can have various arrangements, for example a circular arrangement, so that relative rotation of the component 36 and the PCB 80 can achieve a result in which the ports 40 bonded to different tracks 60 determine a given prize level.

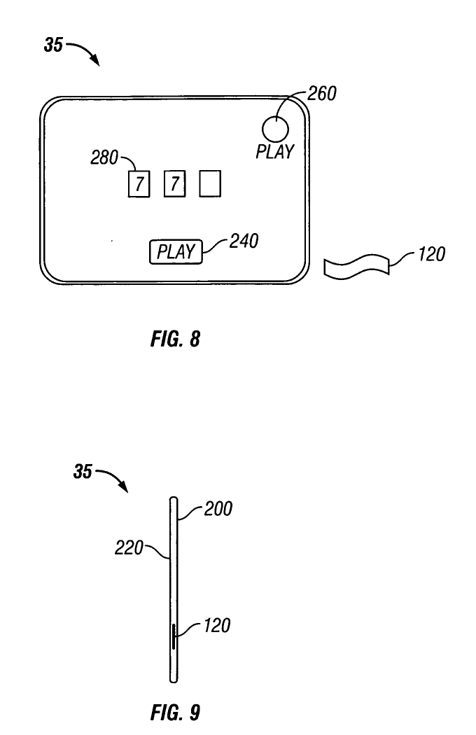

Referring to FIGS. 8 and 9, a game device 35 is shown formed as a rectangular card, for housing a type of device 34 illustrated in FIGS. 7a-c. Other shapes and/or sizes are possible within the scope of the embodiments described herein. The game device 35 includes a front surface 200 and a rear surface 220 between which various parts (PCB, LCD, component, battery, etc.) are disposed. In one example, the game device has an approximate thickness of 3 mm and a surface area similar to a credit card.

With reference also to FIGS. 7a-c, the PCB 80 and/or component 36 can also be bonded to either or both surfaces 200, 220 so that attempts to separate the device will destroy the component 36 and/or PCB 80. The game device 35 includes a play-push button 240, and an “On” button 260. A number of display windows 280 are disposed in the front surface 200 for displaying characters generated during game play. In one example, the display windows 280 are spaced along the length of the device 36. Alternatively a single display window capable of displaying various characters can be provided. The display windows 280 can be a liquid crystal display, or any other type of display, such as a light-emitting diode (LED) display.

To operate the device, according to one possible game, the characters in each of the display windows 280 must match at least one other character in the display windows 280 to produce a winning combination e.g. 77. Alternatively, one or more games can be designed to replicate a number of different play styles, such as: 1) key number match—whereby at least one character in the display windows 280 has to match a number externally generated, for example, on a website; 2) beat the score—where the display windows 280 are divided into two or more play areas to represent multiple players, such as human players and a computer, and the human players' score has to be higher than the computer's score to win; 3) find and win—in which the display windows 280 are divided into several sections and the player has to guess in advance which of the windows a symbol will appear. These games are illustrative, and many other games are possible.

A battery activation tab 120 is also shown which can be pulled out to allow contact to be made with an internal battery to activate the device 35. In one exemplary operation, to play a game, a player first removes the battery tag 120. The windows 280 display the number of plays on the device. The player then presses the play button 240 and characters in the display windows 280 appear to spin. At least one character then appears to come to rest in a first window, and after a small delay, at least one character appears in the second and then third windows.

In this exemplary operation, one of two outcomes can occur: 1) the characters in the windows 280 do not match at least one other—in this case, the player has not won. After a period of time, i.e. 2 seconds, the windows 280 will display the number of plays left e.g. PLAY 24, PLAY 23, and the player then presses the play button 240 again for another set of characters; or 2) two or three characters match, resulting in the player winning. A prize for the winning combination can be predetermined by a promoter, i.e. based on which characters match. For example, a match 77 77 77 means the player wins $10, whereas match 55 55 55 means the player winds a t-shirt.

At this point in the windows 280, the characters flash for a couple of seconds and then the word WIN appears in the display windows 280, followed by a security code relating to the prize level won. The display windows 280 will then revert back to displaying the winning characters, followed by the word WIN and the security code. It will repeat the cycle for interval, after which it the device 35 will turn itself off. Pressing the “on” button 260 will re-power the device 35 and the display windows 280 will revert back to displaying the above sequence. If at any point none of the buttons 240 or 260 are pressed for a time period, i.e. 20 seconds, then the device will turn itself of to conserve battery power. Pressing the “on” button 260 will re-power the unit and it will return to the same status immediately prior to turning itself off.

The prize amount, number of winners of each prize, and the distribution of devices 35 can determined by the promoter, and prizes are distributed according the promoter's game rules and procedures and in compliance with local laws or regulations.

Each component 36 of the number of devices 34, 35 include substantially identical software for running a game or games, and typically a number of connection configurations between a portion of the component ports and the PCB paths can be common to each game, whether or not a winning game has been predetermined for a given device 35. Other ports 40 will be connected in a number of different configurations. The identity and/or combination of the connected ports can determine a win level of a game in accordance with the software programmed on the component 36. The configuration of the ports to be connected can be programmed into an assembly apparatus. Thus, it is possible to obtain tens, hundreds or thousands of different configurations depending on the number of pins and connections to the PCB 80. In another arrangement, the ports/pins 40 on the component 36 and the connections on the PCB 80 can be arranged in a circular fashion so that the component 36 or PCB 80 can be rotated relative to each other, so that the angular displacement prior to the bonding of the component 36 to the PCB 80 will determine the configuration in which the ports 40 are connected to the paths 60 to form the connection configuration.

Once connections between the component 36 and PCB 80 have been made, the bonding may be completed by fixing the component 36 to the PCB 80 using an adhesive such as epoxy resin or the like, so that the component 36 cannot be removed. The component 36 may also be bonded to the gamecard device 34 so that any attempt to open the device will result in the component 36 being destroyed and rendered inoperable. The resin and/or the gamecard device are preferably made opaque so that it is not possible to determine the configuration of the connection between the component 36 and PCB 80, even by, for example, exposure to a strong light source. Additional shielding may also be included in the device 34.

The component 36 may also be programmed with an internal security code generator for generating a security code that is unique to each winning prize and/or prize level, so that a winning game will comprise a security code having a plurality of digits, letters or any other symbols that can be checked against records held by the game organizer of codes programmed into the component 36 to verify a winning game. All components 36 may contain one or more security codes, but the configuration of the bonding of the component 36 to the PCB 80 will determine the security code, if any, that is displayed. Attempts to tamper with the component 36 or PCB 80 will cause the code to not be displayed. The security code may be displayed in a separate window or alternate with display of characters in one or more other windows 280.

The device 34 may also incorporate a random number generator (not shown) separate from the component 35 or encoded in software programmed on the component 35. The random number generator can be used to randomize the sequence in which games are played so that, for example, if a game device includes fifty games, one of which is a winning game, the winning game could occur on any of the fifty game plays rather than the first or any other particular order. More than one winning game may be present on a device 34. Alternatively or in addition, the random number generator can control the sequence of the characters as they are displayed before stopping on the final character for that game. This ensures that the game plays differently each time and enhances the play appeal.

The characters can be any combination of digits, letters or other symbols such as a card suit or pictorial representation of a prize, or combinations thereof. As shown in FIG. 8, the generated characters will appear on a display window or windows 280 provided on the device 35. As a game is played, each character generated can appear as a series of random characters before appearing to come to rest at the predetermined character, and this process will occur either sequentially or simultaneously for each character position to be generated according to the rules of the game being played.

A timer (not shown) may also be incorporated in the device as a countdown mechanism, and which may also include a calendar. The timer can be set to run from production of the device, but since there may be a significant time between production of the gamecard device and its use, in order to preserve the power source, it is preferably activated on activation of the gamecard device. Preferably, the timer is of the type which, on activation, generates a regular series of impulses from which the timing of events is determined. The timer device can be used to track certain events such as the number of times the gamecard 35 can be played over a predetermined time period, e.g. a number of hours, days or weeks. The timing device can be used in conjunction with a game or series of games played over any period of time, especially where a number of games are played over a long period of time. For example, as part of a promotional campaign, the game device can be activated on a particular day or at a particular time and then permit play of a specified number of games for that day or week, and winning combinations of characters can be issued each day for that days game in a newspaper or online ensuring that the game is being played in conjunction with the correct winning characters for that day.

Preferably on activation, the game device 34 will reset the component 36 by momentarily cutting off power to the component 36. This clears the component 36 of any static electricity that has built up during assembly and transit/storage that might prevent the component 36 from operating, and which can cause considerable problems which could render sales economically non-viable.

The game device 35 can be provided with an on/off button 260 to activate the device. Activation may, as an alternative or in addition to the on/off button 260, comprise a tab 120 or other device associated with the battery or power source. For example, the tab 120 may be provided such that removal of the tab 120 from a battery activates the device 35. This ensures that the device 35 is not accidentally activated, and also acts as an additional security measure so that the user can see that the device has not been tampered with prior to purchase. The tab 120 may incorporate a holographic seal or other security features that can indicate whether the device 35 has been tampered with.

Various other security measures in addition to an internal security code can be incorporated in or on the game device 35 to ensure the whether it correlates with a winning device when presented, and also to make apparent if attempts have been made to tamper with the game device 35 or to “read” if a game device 35 includes a winning game. These security measures can include, without limitation, incorporation of a temperature sensitive indicator that will change color if a temperature above a predetermined limit has been applied to the device. Such temperature sensitive indicators are available as discs that can be affixed to a surface of the device. To detect attempts to bend or distort the game device 35 one or more areas of the device 35 may include a lacquer or ink that will crack and or fall off the gamecard if the card is significantly bent or distorted. Such ink or lacquers may for example be used to print the game rules on the game device 35 or as a stripe or border around the edge of the device 35.

The game device 35 may also be provided with a unique barcode, such as on the back of each device 35. A conventional VIRN can also be printed on the device 35 and covered with a latex patch. A range of ink jet or holographic markings can also be encrypted onto the exterior surface of the game device 35 as an additional precaution to control the use of the device 35 from manufacture through to return to the game organizers for verification and payment of a prize.

The devices 34, 35 can be produced using conventional assembly methods and mechanisms which make connections between the component 36 and the PCB 80 under control of a software program. The software controlling the assembly mechanism can be adapted to permit multiple configurations of the connections between the PCB 80 and the ports 40 on the component 36 to determine a win level, so that a predetermined proportion of devices 34, 35 in a given assembly run can be assigned a particular win level.

Although a few embodiments have been described in detail above, other modifications are possible. Other embodiments may be within the scope of the following claims.

1. A game device, comprising:
a component programmed with software for playing one or more games, at least one game having one or more win levels, the component having a plurality of ports being connectable to a printed circuit board in any of a plurality of configurations, each configuration corresponding to an associated win level.

2. A game device in accordance with claim 1, wherein each configuration includes a set position in which the component is applied to the printed circuit board, and in which the plurality of ports are selectively connected to a plurality of tracks of the printed circuit board.

3. A game device in accordance with claim 1, further comprising a random number generator that controls a playing order of the one or more games.

4. A game device in accordance with claim 1, wherein the component includes a display, and wherein the game device further comprises a random number generator that controls an order in which characters are configured to be displayed within the display during a game.

5. A game device in accordance with claim 1, further comprising a timer that controls a number of the one or more games that can be played within a time period.

6. A game device in accordance with claim 5, wherein the timer starts the time period upon activation of the device.

7. A game device in accordance with claim 6, further comprising a removable pull tab that, upon removal, allows connection of the device to a power source to activate the device.

8. A game device in accordance with claim 1, wherein the component is configured for a hard reset upon a first activation of the device.

9. A game device in accordance with claim 1, further comprising a security code generator that generates a security code related to a prize level based on the configuration of the connection between the component and the printed circuit board.

10. A game device in accordance with claim 1, wherein connection of the component to the printed circuit board forms a game card.

11. A game device in accordance with claim 1, wherein the component includes an integrated circuit.

12. A method of producing a game device for playing a game having one or more win levels, the method comprising:
providing a component programmed with software to run the game; and
selectively connecting a plurality of ports on the component to a plurality of tracks on a printed circuit board in one of a plurality of configurations, each configuration corresponding to a predetermined win level of the game.

13. A method in accordance with claim 12, further comprising:
bonding the component to the printed circuit board; and
selectively connecting the plurality of ports on the component to the plurality of tracks on the printed circuit board according to a connection configuration program.

14. A method in accordance with claim 13, wherein the connection configuration program includes a win level limit to prevent more than a predetermined number of game devices from achieving a given win level associated with the game.

15. A method in accordance with claim 12, further comprising:
applying the component to the printed circuit board in a set position;
connecting, in the set position, the plurality of ports on the component to the plurality of tracks on the printed circuit board.

16. A method in accordance with claim 12, further comprising applying a security mechanism to the device to d displayed in said second window group according to the game.
